(19) United States
(12) Patent Application Publication
(10) Pub. No.: US 2007/0088690 A1
(43) Pub. Date: Apr. 19, 2007

(54) System and method for performing file searches and ranking results

(75) Inventors: Kevin Wiggen, San Francisco, CA (US); Barry Lind, Union City, CA (US)

Correspondence Address: Trellis Intellectual Property Law Group, PC, 1900 EMBARCADERO ROAD, SUITE 109, PALO ALTO, CA, 94303, US

(73) Assignee: Xythos Software, Inc., San Francisco, CA (US)

(21) Appl. No.: 11/251,550

(22) Filed: Oct. 13, 2005

(51) Int. Cl. G06F 17/30

(52) U.S. Cl. 707/5

(57) ABSTRACT

A system and method for implementing file searches. In an illustrative embodiment, the method includes accepting signals from a user-input device to define a search query. The search query is then used to identify a plurality of files, which comprise search results. The search results are then ordered according to file-usage criteria. In a more specific embodiment, files that have been accessed by others rank higher in the search results than files that have never been accessed. One or more access logs may be employed to facilitate adjusting future search results and file-access behaviors based on past file-access information. In this specific embodiment, the method employs information pertaining to who accessed a given file, what they did when they accessed the file, the time at which they accessed the file, and/or the duration of the file access to automatically obtain and/or rank search results.

### BACKGROUND OF THE INVENTION

This invention is related in general to file searching, and more specifically, to systems and methods for performing file searches and displaying results of the file searches based on given search criteria.

File searching systems are employed in various demanding applications including file-sharing, music downloading, document word-search tools, and various web-search tools, such as Google®, Yahoo®, and so on. Such applications demand efficient search engines that can readily and accurately find and list desired files.

Accurate and versatile searches are particularly important in server-based and network-based applications, where searches are often performed on millions of files with extraordinarily diverse content. Conventional search engines, such as Google®, Yahoo®, Lycos®, Windows Explorer® search tools, and so on, enable users to initiate various searches based on keywords or combinations thereof.

### SUMMARY OF THE INVENTION

Certain embodiments of the present invention provide a system for implementing file searches, such as digital-file searches. One embodiment includes a first mechanism for maintaining access information associated with plural files. A second mechanism receives search criteria pertaining to the access information. A third mechanism searches for files that match or partially match the search criteria and then provides search results in response thereto. A fourth mechanism orders the search results according to a degree by which each file of the search results matches the search criteria.

In a more specific embodiment, files that have been accessed by others rank higher in the search results than files that have never been accessed. File-access logs facilitate adjusting future search results based on previous file-access information obtained monitored by the system. In this specific embodiment, the system employs information pertaining to who accessed a given file, what they did when they accessed the file, the time at which they accessed the file, and/or the duration of the file access to automatically obtain and/or sort search results.

Further examples of file-access information, also called usage data or user-access information, include data specifying one or more persons that accessed a file, an original author of a file, one or more persons that did not access a file, one or more groups or members thereof that accessed a file, when a file is was accessed, file-editing time, numbers of keystrokes employed during editing of a file, time intervals between when a file was accessed, and data specifying if and when contents of a file were printed.

Hence, unlike conventional file-searching systems, certain embodiments of the present invention employ search criteria pertaining to file-access information to obtain more relevant search results. Users can now search and sort files based on who used a given file, when they used it, which group the person is associated with, and so on. An additional keyword search module or other type of search module may be employed to provide additional flexibility in enabling search results to be based on a desired combination of keywords, file-access information, and/or other search criteria. Search results may then be conveniently displayed according to the degree by which they match the customizable search criteria.

### BRIEF DESCRIPTION OF THE DRAWINGS

FIG. 1 is a diagram of a system for implementing accurate and versatile file searches according to an embodiment of the present invention.

FIG. 2 is a diagram illustrating exemplary search-configuration screens displayed by the system of FIG. 1.

FIG. 3 is a diagram illustrating an exemplary result-display screen displayed by the system of FIG. 1 in response to a file search.

FIG. 4 is a flow diagram of an exemplary method employed by the system of FIG. 1.

### DETAILED DESCRIPTION OF EMBODIMENTS OF THE INVENTION

For clarity, various well-known components, such as power supplies, operating systems, communications ports, hubs, modems, gateways, firewalls, network cards, Internet Service Providers (ISPs), and so on, have been omitted from the figures. However, those skilled in the art with access to the present teachings will know which components to implement and how to implement them to meet the needs of a given application.

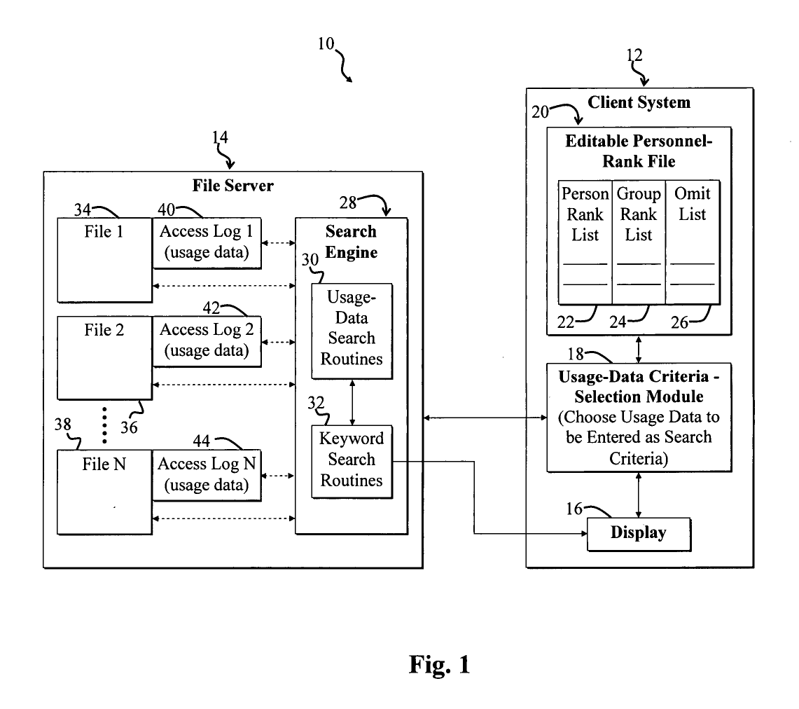

FIG. 1 is a diagram of a system 10 for implementing accurate and versatile file searches according to an embodiment of the present invention. The system 10 includes a client system 12 in communication with a file server 14. The client system 12 includes a display 16, which communicates with a usage-data criteria-selection module 18, which communicates with an editable personnel-rank file 20 stored on the client system 12. The editable personnel-rank file 20 maintains various rank lists, including a personnel-rank list 22, a group rank list 24, and an omit list 26.

The file server 14 includes a search engine 28, which includes usage-data search routines 30, which communicate with keyword search routines 32. The search engine 28 and accompanying modules 30, 32 selectively access, for searching purposes, plural files 34-38 and accompanying access log information 40-44. In the present illustrative embodiment, the search engine 28 selectively searches N files and N corresponding access logs, including a first file 34 and accompanying access log 40, a second file 36 and accompanying access log 42, and an N^{th} file 38 and accompanying access log 44.

For the purposes of the present discussion, a file may be any piece of information stored via an electronically accessible storage medium, including image data, text, executables, meta-data that the storage medium may be storing along with the bytes representing other file data, and so on. Usage data may be any type of information indicating how or when a file has been used. Examples of usage data include names of persons accessing a file, names of groups associated with persons accessing a file, when a file was accessed by a person or group, file-editing time, what edits were made to a file, who made edits to a file, numbers of keystrokes occurring during modification of a file, names of an original author(s) of a file, and so on. The terms auxiliary file information, file-access information, access-log information, and usage data are employed interchangeably in the present discussion. Similarly, auxiliary-file criteria, usage-data criteria, usage-data search criteria, access-log criteria, and file-access criteria, and file-usage criteria, are used interchangeably.

In operation, the file server 14 employs the access logs 40-44 to track and maintain usage data pertaining to each file 34-38. The search engine 28 employs search criteria retrieved from the client system 12 to selectively search the access logs 40-44 and accompanying files 34-38.

A user employing the client system 12 may employ the display 16 as a user interface to enter file search criteria. The usage-data criteria-selection module 18 communicates with the display 16 to facilitate enabling the user to specify usage-data criteria, keyword criteria, and/or other criteria to facilitate file searches.

Alternatively, the usage-data criteria-selection module 18 automatically determines usage-data search criteria by observing users, such as via the user interface represented by the display 16. In this operative scenario, usage-data criteria-selection module 18 runs routines adapted to automatically establish the usage-data search criteria based on information automatically obtained by the usage-data criteria-selection module 18 about users of the system 12 through observations of the users. For example, the usage-data criteria-selection module 18 may observe a user operating a computer in an accounting department of a company. Furthermore, the usage-data criteria-selection module 18 may be preprogrammed with information indicating the boss of the accounting department. Alternatively, the usage-data criteria-selection module 18 may obtain this information by querying a separate database (not shown) that maintains company information. According to the present example, if the user performs a file search via the system 12, files accessed by the boss of the accounting department may rank higher in a search-results list than files not accessed by the boss.

For the purposes of the present discussion usage-data criteria may be any information specifying a preference based on usage data. For example, usage-data criteria could specify that all files returned in a search be files that were accessed in the previous week by members of a certain group as indicated by the usage data maintained in the access logs 40-44.

The usage-data criteria-selection module 18 runs software to generate various screens displayed via the display 16 that enable a user to specify search criteria, as discussed more fully below. The usage-data criteria-selection module 18 and accompanying display 16 further enable a user to edit the personnel-rank file 20.

The personnel-rank file 20 maintains the prioritized lists 22-26, which specify, in priority order, which persons and/or groups of persons will be involved or will be omitted from a given search. For example, the personnel-rank list 22 may list a user's boss as the highest priority person, followed by the user's associate, and so on. The group-rank list 24 may list a group that the user belongs to as the highest priority group, followed by a group that the user's boss belongs to, and so on. The omit list 26 may specify, for example, that people from a quality-control group, which may access most files, be omitted from a search. In the present example, a search employing this personnel-rank file will generally list search results for files accessed by the user's boss above those accessed by the user's associate. Files associated with the group that the user's boss belongs to will be listed after those files accessed by the user's group. In the present example, whether or not the quality-control group has accessed a given file will not factor into the ranking, i.e., listing order of search results returned by the search engine 28 to the display 16.

In one implementation, the file server 14 and/or the usage-data criteria-selection module 18 automatically determines usage data to be employed for a given search and implements the search in response thereto. In such an implementation, the system 10 may automatically know who the superiors of a particular user are, which groups a particular user belongs to, and so on. The system 10 then automatically ranks search results based on automatically selected search criteria selected based on knowledge of a particular user. The knowledge of a particular user may be obtained in various ways, such as by employing software running on the usage-data criteria-selection module 18 to track file usage patterns of a particular user. Hence, in this implementation, usage-data criteria selection and related searching algorithms are transparent to the user.

Note that a user may be any person, device, application, or machine that employs the system 10. For example, a user may be another computer or application that employs the system 10 to implement searches. For example, another computer may employ the system 10 to determine which files have been accessed by a particular group in a predetermined time frame, or a particular group may wish to retrieve files accessed by the chief financial officer.

Exact implementation details, such as details specifying whether a person in the personnel-rank list 22 is associated with a higher priority than a particular group listed in the group-rank list 24, are application specific. Those skilled in the art with access to the present teachings may readily implement such details to meet the needs of a given application without undue experimentation.

In the present embodiment, the user employs the display 16, the usage-data criteria-selection module 18, and the editable personnel-rank file 20 to specify search criteria based on a prioritization of usage data, keyword data, other search criteria, or combinations thereof. The usage-data criteria-selection module 18 then forwards the resulting search criteria to the search engine 28.

In one example, the search criteria entered via the display 16 involves a search based on persons that accessed each searched file in accordance with the personnel-rank list 22 of the editable personnel-rank file 20, the results of which are to be ordered based on occurrences of keywords in each file. In this operative scenario, the usage-data search routines 30 search the access logs 40-44 and retrieve a set of files that are ordered according to the personnel-rank list 22. The resulting set of files is then further sorted by the keyword search routines according to numbers of occurrences of key words. For example, if the usage-data search routines 30 return five files edited by a user's boss followed by five files edited by the user's associate, the keyword search routines would sort the first five files in order based on which files contained the most occurrences of the desired keywords. The subsequent five files edited by the user's associate would be listed after the first five files, but would also be listed in order based on numbers of occurrences of keywords occurring in each file.

In another operative scenario, keyword search criteria may be prioritized ahead of usage-data search criteria. In this case, a keyword search is first performed, and the results are then sorted according to the usage-data criteria.

In yet another operative scenario, the prioritization of search criteria, such as the prioritization of usage-data search criteria versus keyword search criteria and other types of criteria, may be determined via a detailed algorithm or method adapted to meet the needs of a given application. Such a detailed algorithm might specify, for example, that files exhibiting a given number of keywords be prioritized above files that were edited by a user's boss.

In yet another operative scenario, the display 16 accepts signals from a user, wherein the signals define a search query. The search query is then employed by the usage-data criteria-selection module 18 to identify a plurality of files, which comprise search results. The search results are then ordered by software running on the usage-data criteria-selection module 18 according to file-usage criteria.

In a more specific scenario, files that have been accessed by others rank higher in the search results than files that have never been accessed. One or more of the access logs 40-44 may be employed by the search engine 28 and the usage-data criteria-selection module 18 to facilitate adjusting future search results and associated file-access behaviors of the system 10 based on past file-access information.

In this specific embodiment, the usage-data criteria-selection module 18 employs information pertaining to who accessed a given file, what they did when they accessed the file, the time at which they accessed the file, and/or the duration of the file access to automatically obtain and/or rank search results. For example, files accessed by a user's group may rank higher than files accessed by those outside of the group. As another example, a file that was quickly accessed might have been mistakenly accessed, while one that was kept open for an hour may have more importance, and consequently, may be ranked higher by the system 10. In another scenario, the access pattern for a file might be cyclical. For example, an insurance provider might access a file every September. In this case, files previously accessed by the insurance provider may be more highly prioritized by the system 10 in September.

Hence, unlike conventional file-search systems, the system 10 of FIG. 1 facilitates ranking search results based on file-access information, including information specifying who accessed a given file and their relevancy to a given search. Additional file-access information, including file editing time, numbers of keystrokes employed for edits, and so on, may be employed to rank search results or to perform initial searches. In addition, characteristics of persons accessing files may be employed in a search, such as which groups the persons belong to. In general, any type of information that can be stored in the access logs 40-44 may be employed to perform searches and/or to sort and order search results.

Those skilled in the art with access to the present teachings may readily implement or order the various modules 12-44 of FIG. 1 without undue experimentation.

While in the present illustrative embodiment, the files 34-38 are shown listed, the files 34-38 may be stored in a directory tree or other format or organization without departing from the scope of the present invention. Furthermore, the editable personnel-rank file 20 and the usage-data criteria-selection module 18 of FIG. 1 may be implemented in another location, such as in a separate remotely accessible computer, without departing from the scope of the present invention.

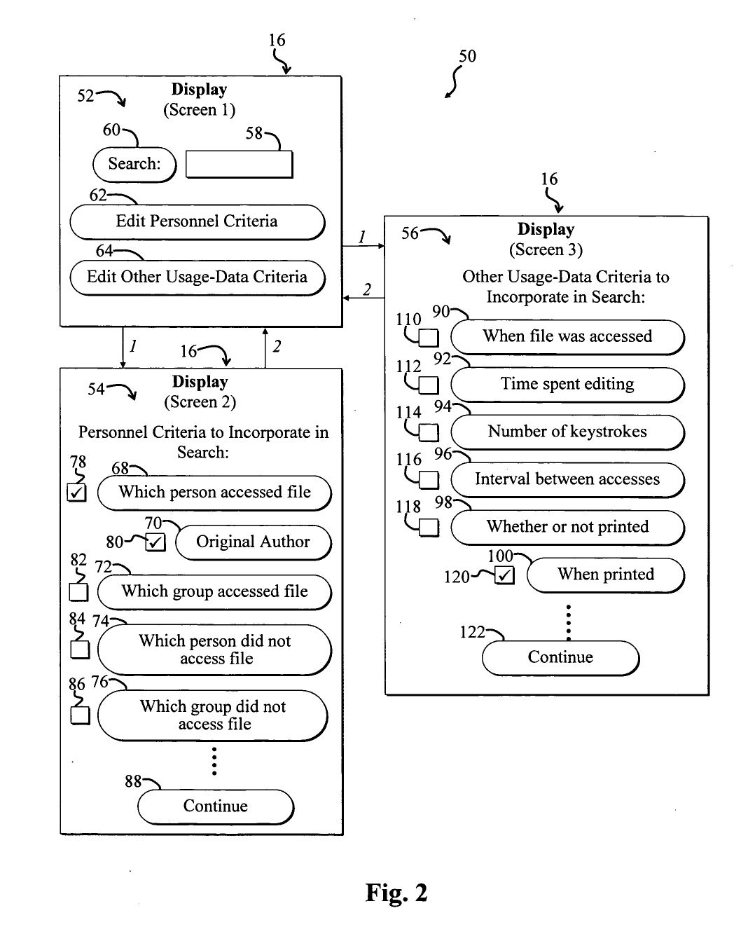

FIG. 2 is a diagram illustrating exemplary search-configuration screens 50 displayed by the system 10 of FIG. 1. With reference to FIGS. 1 and 2, the screens 50 are displayed via the display 16. The screens 50 include an initial screen 52, a second screen 54, and a third screen 56. The initial screen 52 includes a keyword search field 58 adjacent to a search button 60. The keyword search field 58 may accept various types of search criteria to facilitate searching files for phrases, numbers of keywords, proximity of keywords to other keywords, omitted words or phrases, and so on. Alternatively, searches may be performed via a web service Application Programming Interface (API) with little or no user interaction to allow for programmatic search queries or queries from other computer programs.

The initial display screen 52 further includes an edit-personnel-criteria button 62 and an edit-other-usage-data-criteria button 64. Selection of the edit-personnel-criteria button 62 causes the usage-data criteria-selection module 18 of FIG. 1 to display the second screen 54 via the display 16. Alternatively, the buttons 62, 64 are omitted, and associated search criteria is automatically determined via one or more routines running on the usage-data criteria-selection module 18 of FIG. 1 that are adapted to monitor user usage patterns and/or other data to ascertain appropriate search criteria.

The second screen 54 includes various additional buttons 68-76 associated with accompanying check boxes 78-86, respectively, in addition to a first continue button 88 at the bottom of the second screen 54. The various buttons 68-76 include a user-access button 68, an original-author button 70, a group-access button 72, a person-to-omit button 74, and a group to omit button 76. Each button 68-76 may activate a separate screen (not shown) that may enable a user to further specify details for each category of criteria associated with each button. For example, the user-access button 68 may activate a screen enabling a user to list persons in a specific order for incorporation into the personnel-rank list 22 of FIG. 1. The original-author button 70 may activate a screen enabling a user to list names of original authors to be included in the editable personnel-rank file 20 and to be further incorporated into file-access criteria to be included in a search to be implemented via the search engine 28. Similarly, the remaining buttons 72-76 may activate screens enabling a user to specify priorities for search criteria based on groups accessing files, persons and groups that did not access files, and so on.

The check boxes 78-86 adjacent to the buttons 68-76 enable a user to selectively include or omit different categories of personnel search criteria to be included in a given search. For example, in the present embodiment, a user has selected to implement a file search based on who accessed a file and who originally authored the file as indicated by the checked boxes 78, 80, which are adjacent to the person-access button 68 and the original-author button 70. Similarly, unchecked boxes adjacent to the remaining buttons 72-76 indicate that group-access criteria, and so on, will not be incorporated in the present search. After the user completes editing search criteria via the second screen 54, the continue button 88 is pressed, the initial screen 52 is displayed.

Selection of the edit-other-usage-data-criteria button 64 in the initial screen 52 causes the usage-data criteria-selection module 18 of FIG. 1 to display the third screen 56 via the display 16. The third display screen 58 includes various buttons 90-100 and adjacent check boxes 110-120, respectively, that enable a user to selectively adjust usage-data search criteria other than person or group-specific search criteria. For illustrative purposes, the buttons 90-100 displayed via the third screen 56 include an access-time button 90, an editing-time button 92, a keystroke-number button 94, an access-interval button 96, a print-status button 98, and a print-time button 100. Selection of the access-time button 90 activates another screen (not shown) that enables a user to prioritize access-time search criteria. For example, a user may choose to list search results in order of when the files were accessed by selecting box 110 and configuring access-time information via the access-time button 90. Alternatively, a user may specify that only files that were accessed in the past week be included in search results by specifying the access-time criteria to require such. To incorporate specified access-time criteria in a given search, a user simply checks box 110 after performing necessary edits of the access-time criteria by selecting the access-time button 90.

Additional examples of access-time criteria editable via the button 90 include information specifying that files that are historically accessed more often in a particular time frame be ranked higher during those time frames. For example, files that are accessed frequently every December may be given higher priorities in December, such that they will rank higher in December search results. Alternatively, recent file-access frequency may be employed such that files accessed most frequently within a recent predetermined time frame are ranked higher than those that were less frequently accessed. For example, the predetermined time frame may include the past ten days. Consequently, the most frequently used files in the previous ten days may be ranked above those that were less frequently used within the past ten days.

Similarly, the editing-time button 92 activates another screen or dialog box (not shown) that enables a user to specify editing-time search criteria. For example, a user may employ the editing-time criteria to limit search results or to sort search results. For example, a user may cause search results to be ordered based on total time spent editing a given file or may cause search results to be limited to those files exhibiting editing times within a specified time range. To incorporate specified editing-time criteria in a given search, a user simply checks box 112 associated with the editing-time button 92 before selecting the continue button 88, which activates the initial display 52.

Similarly, the keystroke-number button 94 enables a user to specify keystroke search criteria. For example, the keystroke search criteria may specify that returned search results be ordered based on numbers of keystrokes occurring in each file. Alternatively, all results returned may exhibit a predetermined number of editing keystrokes or the number of editing keystrokes may fall within a predetermined specified range. Such keystroke search criteria may be entered via a screen (not shown) activated in response to selection of the keystroke-number button 94.

Similarly, the access-interval button 96 facilitates enabling a user to specify search criteria pertaining to the frequency with which a file is accessed. The print-status button 98 facilitates enabling a user to specify search criteria pertaining to whether or not a file was printed and/or how many times the file was printed. The print-time button 100 facilitates enabling a user to specify search criteria pertaining to a time or time interval when a file was printed.

In the present illustrative scenario, the check box 120 adjacent to the print-time button 100 is selected. Consequently, the current search will be performed using criteria pertaining to when files were printed. The user may have specified, such as via a screen activated in response to selection of the print-time button 100, that search results should be ordered according to when they were printed. The remaining checkboxes 110-118 of the third screen 56 are unchecked, and consequently, the associated adjacent criteria specifications 90-98 are not incorporated in the present search.

Pressing an additional continue button 122 in the third screen 56, activates the initial screen 52. In the present illustrative scenario, after desired criteria/criterion are/is edited and configured and any desired keyword search criteria are entered in the field 58, a user presses the search button 60 to activate a search. In the present operative scenario, the search is performed based on the criteria configured via the user-access button 68 and the author button 70 of the second screen 54 and the print-time button 120 of the third screen 56, which are adjacent to selected check boxes 68, 70, 120, respectively. The subsequent search results are retrieved, sorted, and then displayed according to the specified criteria.

Exact details for implementing various screens, including screens associated with activation of the various buttons 68-76 and 90-100, are application-specific and may be readily implemented by those skilled in the art with access to the present teachings to meet the needs of a given application without undue experimentation.

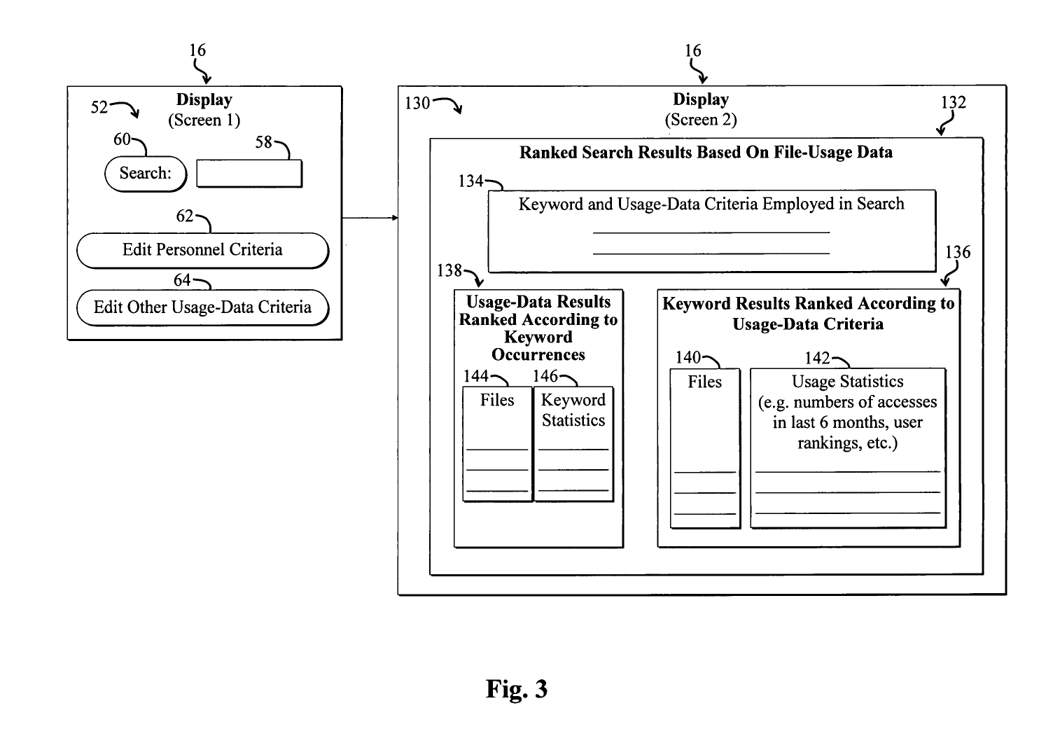

FIG. 3 is a diagram illustrating an exemplary result-display screen 130 employed by the system 10 of FIG. 1 in response to a file search. The illustrative result-display screen 130 includes a ranked-results box 132 that includes a criteria-indication section 134, a keyword-results section 136, and a usage-data-results section 138.

The criteria-indication section 134 lists or otherwise specifies criteria employed in a particular search, such as keywords and/or key phrases and types of usage-data criteria that were employed to implement the search. For example, the criteria-indication section 134 may indicate that files occurring in the current search results were printed in the past month (see button 100 and box 120 of FIG. 2) that were originally authored by an associate (see button 70 and box 80 of FIG. 2) that were reviewed by the user's boss (see button 68 and box 88 of FIG. 2), and that contain specified keywords that were entered in the keyword search field 58.

In the present illustrative embodiment, the keyword-results section 136 lists files that were returned by the search that match the keyword search criteria and that match, to varying degrees, the specified usage-data criteria. The files are then listed in a first sorted-files section 140 in order based on the degree by which the files match the specified usage-data criteria. For example, files that match all of the specified keywords and all of the usage-data criteria are listed near the top of the first sorted-files section 140. Files that match all of the specified keywords and the majority of the usage-data criteria are listed next. Files that match all of the specified keywords and only one of the specified usage-data criterion are listed last. Other types of listing methodology may be employed without departing from the scope of the present invention. For example, files may also be sorted according to the degree by which files match specified keyword search criteria. For example, files exhibiting more keywords may match the keyword search criteria to a greater degree and could be sorted accordingly.

Usage-data statistics 142 are listed adjacent to each file in the first sorted-files section 140. The Usage-data statistics 142 specify usage-data information associated with each listed file that pertains to the usage-data criteria used for the search and displayed in the criteria-indication section 134.

The usage-data-results section 138 includes a second sorted-files section 144 listing all found files matching specified usage-data search criteria. The matching files 144 are sorted based on occurrences of keywords occurring in each file, i.e., based on the degree to which the files 144 match the specified keyword-search criteria. Keyword statistics 146 are listed adjacent to the associated sorted-files section 144. The sorted-files sections 140,144 and accompanying statistics sections 146, 142, respectively, enable users to readily visualize and ascertain how search results match specified criteria.

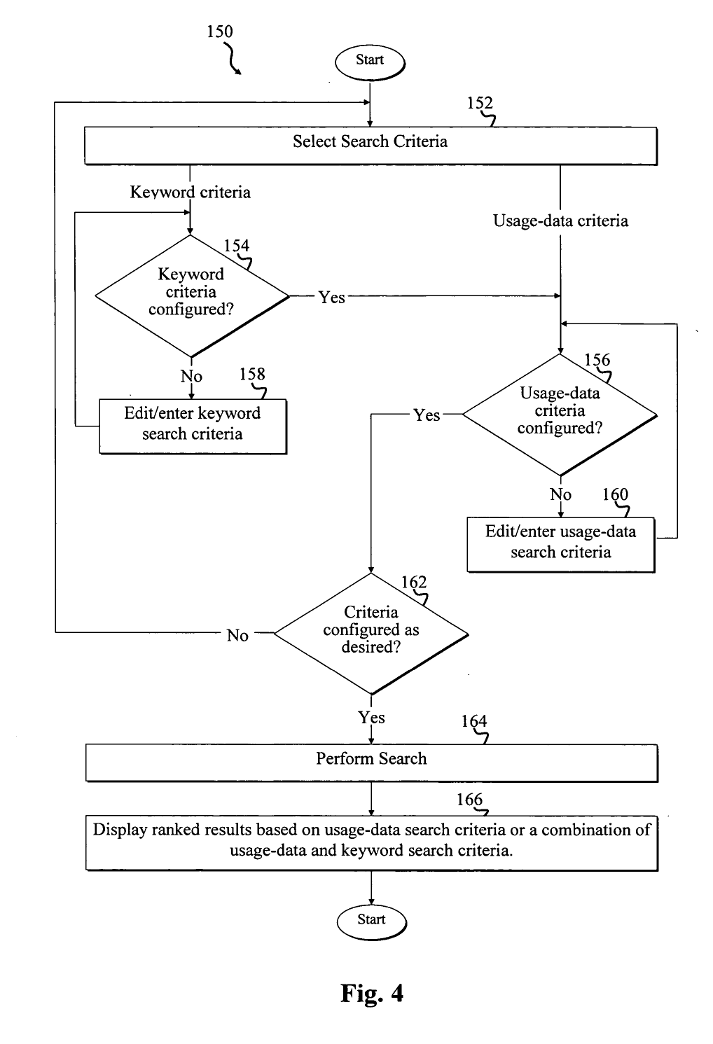

FIG. 4 is a flow diagram of an exemplary method 150 employed by the system 10 of FIG. 1. With reference to FIGS. 1 and 4, the method 150 includes an initial criteria-selection step 152, wherein a user enters search criteria via a user interface, such as the display 16, into the usage-data criteria-selection module 18. If keyword-search criteria are initially entered, then a keyword-configuration-checking step 154 is performed next. Otherwise, if usage-data criteria are initially entered in the criteria-selection step 152, then a usage-data-configuration-checking step 156 is performed next.

The keyword-configuration-checking step 154 includes verifying whether or not keyword-search criteria has been properly entered and configured. If desired keyword-search criteria are complete and have been properly entered and configured, then the usage-data-configuration-checking step 156 is performed next. Otherwise, a keyword-criteria-editing step 158 is subsequently performed.

In the keyword-criteria-editing step 158, the user enters additional keyword search criteria and/or edits existing keyword search criteria before the keyword-configuration-checking step 158 is performed again. The keyword-criteria-editing step 158 is performed until the keyword criteria are configured as desired as verified in the keyword-configuration-checking step 154. Subsequently, usage-data-configuration-checking step 156 is performed.

The usage-data-configuration-checking step 156 includes determining if usage-data search criteria has been entered and configured as desired. If usage-data search criteria has been entered and configured as desired, then a usage-data-editing step 160 is performed next.

The usage-data-editing step 160 includes editing and/or entering desired usage-data search criteria. The usage-data-editing step 160 is performed until usage-data search criteria are complete, configured, and entered as desired as verified by the usage-data-configuration-checking step 156. If usage-data search criteria has been entered and configured as desired, then a total-criteria-checking step 162 is performed.

The total-criteria-checking step 162 includes verifying that all desired criteria, including any keyword-search criteria and usage-data-criteria has been entered and configured as desired. If all criteria has not been entered and configured as desired, then the criteria-selection step 152 is resumed. Otherwise, a file search is initiated in a searching step 164.

In the present specific embodiment, if usage-data criteria are entered first, then the searching step 164 initially performs a search for files based on usage data, which are subsequently sorted based on the degree to which the returned files match any entered keyword search criteria. Conversely, if keyword-search criteria are entered first, the searching step 164 initially performs a search for files that match the keyword search criteria. The resulting files are then sorted according to the degree with which they match the usage-data criteria. Exact details of the implementation of step 164 are application specific and may be changed or adjusted to meet the needs of a given application without departing from the scope of the present invention.

Subsequently, search results are displayed in a displaying step 166. The search results are ranked based on usage-data search criteria and/or a combination of usage-data and keyword search criteria. The ranked search results are then displayed via the display 16 of FIG. 1, such as indicated via the screen 130 of FIG. 3.

The keyword search criteria, which may include criteria specifying desired phrases, i.e., phrase-search criteria, may be replaced with another type of criteria, such as file-size criteria, without departing from the scope of the present invention. Furthermore, certain steps of the method 150 may be reordered, deleted, or interchanged with other steps without departing from the scope of the present invention. Furthermore, various steps of the method 150. For example, steps 154, 158 may be deleted, replaced, and/or incorporated into steps 156, 160.

Note that some of steps 150-164 may be automatically performed by the system 10 of FIG. 1. For example, the system 10 of FIG. 1 may automatically perform steps 156, 160, i.e., the system 10 may automatically determine and configure the usage-data criteria to be used in the search step 164 and/or the displaying step 166.

Although the embodiments of the present invention have been discussed with respect to file searches based on usage-data and keyword, other types of auxiliary file information may be used in file searches without departing from the scope of the present invention. For example, information indicating where the file was sent, what font appears in the file, whether the document has embedded objects, and so on, may be used.

Although the invention is discussed primarily with respect to content maintained on a file server and selectively accessed via a client system, any suitable file storage medium, network topology, transmission protocols, sender-receiver devices and relationships, and other characteristics or properties of electronic devices, processes and transmission methods can be used. For example, the file server 14 may be implemented via the Internet and may represent plural file servers, data storage networks, and so on. In general, any network or communication arrangement can be suitable for use with embodiments of the invention. Also, any communication protocols or other features or characteristics of data transfer may be employed.

While the present embodiment is discussed with reference to systems and methods for facilitating file searches based on auxiliary file information, embodiments of the present invention are not limited thereto. For example, any type of file data, either contained in the file or contained in an auxiliary log may be employed in file searches without departing from the scope of the present invention.

Although embodiments of the invention are discussed primarily with respect to server-client architecture, any acceptable architecture, topology, protocols, or other network and digital processing features can be employed. In general, network controllers, managers, access points, clients, and so on, required for a particular implementation, can be implemented via any device with processing ability or other requisite functionality.

Although processes of the present invention and the hardware and/or software executing the processes may be characterized by language common to a discussion of the Internet (e.g., “client,” “server,” “peer”), it should be apparent that operations of the present invention can execute on any type of suitable hardware in any communication relationship to another device on any type of link or network.

Although a process of the present invention may be presented as a single entity, such as software executing on a single machine, such software can readily be executed on multiple machines. That is, there may be multiple instances of a given software program, a single program may be executing on two or more processors in a distributed processing environment, parts of a single program may be executing on different physical machines, etc. Furthermore, two different programs, such as a client and server program, can be executing in a single machine, or in different machines. A single program can be operating as a client for one information transaction and as a server for a different information transaction.

Any type of processing device can be used as a client. For example, portable computing devices such as a personal digital assistant (PDA), cell phone, laptop computer, or other devices can be employed. In general, the devices and manner of specific processing (including location and timing) are not critical to practicing important features of the present invention.

Although the invention has been discussed with respect to specific embodiments thereof, these embodiments are merely illustrative, and not restrictive, of the invention. Embodiments of the present invention can operate between any two processes or entities including users, devices, functional systems, or combinations of hardware and software. Peer-to-peer networks and any other networks or systems where the roles of client and server are switched, change dynamically, or are not even present are within the scope of the invention.

Any suitable programming language can be used to implement the routines or other instructions employed by various network entities. Exemplary programming languages include C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “machine-readable medium” or “computer-readable medium” for purposes of embodiments of the present invention may be any medium that can contain, store, communicate, propagate, or transport a program for use by or in connection with an instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented in whole or in part by using a programmed general purpose digital computer; by using application specific integrated circuits, programmable logic devices, field programmable gate arrays, optical, chemical, biological, quantum or nanoengineered systems or mechanisms; and so on. In general, the functions of the present invention can be achieved by any means as is known in the art. Distributed or networked systems, components, and/or circuits can be used. Communication, or transfer of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A system for implementing a file search comprising:
first means for maintaining access information associated with plural files;
second means for receiving search criteria pertaining to the access information;
third means for searching for files that match or partially match the search criteria and providing search results in response thereto; and
fourth means for sorting the search results by ordering files associated with the search results according to a degree by which each file of the search results matches the search criteria and providing sorted search results in response thereto.

2. The system of claim 1 further including
fifth means for automatically establishing the search criteria based on information automatically obtained by the fifth means about a user of the system.

3. The system of claim 1 wherein the access information includes
data naming one or more persons that accessed a file.

4. The system of claim 1 wherein the access information includes
data specifying an original author of a file.

5. The system of claim 1 wherein the access information includes
data specifying one or more persons or groups that did not access a file.

6. The system of claim 1 wherein the access information includes
data specifying one or more groups or members thereof that accessed a file.

7. The system of claim 1 wherein the access information includes
data specifying when a file is was accessed, data specifying file-editing time, data specifying numbers of keystrokes employed during editing of a file, data specifying time intervals between when a file was accessed, and/or data specifying if and when contents of a file were printed.

8. A system for performing a file search based on auxiliary file information comprising:
one or more logs adapted to maintain the auxiliary file information pertaining to one or more files to be searched by the system;
a usage-data criteria-selection module adapted to enable a user to enter usage-data search criteria; and
one or more search routines adapted to employ the usage-data search criteria to search the auxiliary file information and produce ordered search results in response thereto.

9. The system of claim 8 wherein the ordered search results are ordered in accordance with a degree by which auxiliary file information matches the usage-data search criteria.

10. A system for performing a file search comprising:
an editable personnel-rank file;
a usage-data criteria-selection module;
plural files, one or more of the plural files being associated with auxiliary information; and
a search engine in communication with the editable personnel-rank file and the usage-data criteria-selection module, the search engine including:
one or more usage-data search routines, the one or more usage-data search routines in selective communication with the plural files and associated auxiliary information.

11. The system of claim 10 wherein the auxiliary information is stored in access-logs associated with the plural files.

12. The system of claim 10 wherein the search engine further includes
one or more keyword search routines.

13. The system of claim 12 further including
a user interface adapted to enable a user to enter keyword search criteria suitable for use with the one or more keyword search routines.

14. The system of claim 12 wherein the user interface further includes
one or more screens adapted to facilitate implementing a search based on a combination of the keyword search criteria and usage-data search criteria collected by the usage-data criteria-selection module.

15. The system of claim 10 wherein the editable personnel-rank file maintains
usage-data selection criteria based on persons or groups that may have accessed or otherwise modified or used each of the files, the usage-data selection criteria employed by the one or more usage-data search routines to produce search results.

16. The system of claim 15 further including
a display screen that displays the search results according to a degree by which each file of the search results matches the usage-data selection criteria.

17. A method for implementing a file search, the method comprising:
accepting signals from a user-input device to define a search query;
using the search query to identify a plurality of files in search results; and
ordering the search results according to one or more file-usage criteria.

18. The method of claim 17 wherein the ordering of search results uses a degree by which auxiliary file information corresponds to the file-usage criteria.

19. The method of claim 17 wherein the auxiliary information includes file-usage data.

20. The method of claim 19 wherein the file usage data is stored in one or more access-logs associated with each file of the search results.

21. A method for implementing a file search comprising:
performing a search of auxiliary information associated with plural files and providing usage-data search results in response thereto;
implementing a keyword search of files associated with the usage-data search results and providing one or more values in response thereto; and
ordering the usage-data search results according to the one or more values.

22. A method for implementing a file search comprising:
collecting keyword-search criteria;
obtaining usage-data search criteria; and
selectively performing a search of plural files based on an initial search employing the keyword-search criteria or the usage-data search criteria, the initial search producing initial results, the initial search followed by a subsequent search employing the usage data search criteria or the keyword-search criteria, respectively, to facilitate sorting the initial results.

23. An apparatus for transferring information in a digital network, wherein a user device is coupled to the digital network, the apparatus comprising
a processor;
a machine-readable medium including instructions executable by the processor for
receiving a signal from the user device to search for content based on auxiliary file information;
sending a portion of the content from a first location to the user device; and
ordering the portion of the content based on the auxiliary information.

24. A system for implementing a file search comprising:
first means for maintaining access information associated with plural files;
second means for receiving keyword search criteria;
third means for searching for files that match or partially match the keyword search criteria and identifying search results in response thereto;
fourth means for ordering files associated with the search results according to file access information; and
fifth means for providing a list of the ordered files.
